(19) United States
(12) Patent Application Publication
(10) Pub. No.: US 2023/0215170 A1
(43) Pub. Date: Jul. 6, 2023

(54) SYSTEM AND METHOD FOR GENERATING SCORES AND ASSIGNING QUALITY INDEX TO VIDEOS ON DIGITAL PLATFORM

(71) Applicants: LAKSHYA GUPTA, San Jose, CA (US); LAKSHMINATH REDDY DONDETI, San Jose, CA (US); VIDYA NARAYANAN, San Jose, CA (US)

(72) Inventors: LAKSHYA GUPTA, San Jose, CA (US); LAKSHMINATH REDDY DONDETI, San Jose, CA (US); VIDYA NARAYANAN, San Jose, CA (US)

(21) Appl. No.: 18/092,457

(22) Filed: Jan. 3, 2023

Related U.S. Application Data
(60) Provisional application No. 63/296,509, filed on Jan. 5, 2022.

(51) Int. Cl. G06V 20/40; G06T 7/00; G06V 10/94; H04N 5/77

(52) U.S. Cl. CPC G06V 20/41; G06T 7/0002; G06V 10/95; H04N 5/77; G06T 2207/10016; G06V 2201/09; G06T 2207/30201; G06T 2207/30168

(57) ABSTRACT

Exemplary embodiments of the present disclosure are directed towards system and method for generating scores and assigning quality index to videos on digital platform, comprising computing device that comprises video uploading module configured to allow user to record and upload videos on computing device, thereby transferring user uploaded videos to server over network. Server comprising video evaluating module configured to receive user uploaded videos and identifying video frames, thereby identifying different criteria. Video evaluating module configured to evaluate different criteria assigning scores to video frames and computing plurality of metrics of video frames based on assigned scores, then calculates mean and median values of metrics and assign mean and median values of video frame vectors, and combine video frame vectors of each video frame to obtain final video vector. Video evaluating module configured to assign weight to each value of final video vector to identify video quality index.

### CROSS-REFERENCE TO RELATED APPLICATIONS

This patent application claims priority benefit of U.S. Provisional Patent Application No: 63/296,509, entitled “METHOD AND APPARATUS FOR SCORING VIDEOS AND ASSIGNING A VIDEO QUALITY INDEX ON SOCIAL MEDIA PLATFORMS”, filed on 5 Jan. 2022. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates to automatically assigning vector values to a video to measure the quality and potential virality of the video. Secondly, it adds scores to the video on a number of predefined labels based on various aspects. Lastly, it refers to combining the values of this vector to compute video quality indexes using multiple methods suitable for the particular task.

### BACKGROUND

Nowadays, video posting and sharing are growing over digital platforms, and users share their memories and events of life with friends around the world. Smartphones are now commonly used to record videos and have internet access for sharing on digital platforms such as Facebook, Twitter, Tumblr, Google Plus, and the like. Users upload and share videos on digital platforms, but the digital platforms need to moderate the content uploaded by the users. Some existing video platforms have tools to automatically moderate content in addition to having human moderators, but they have their drawbacks.

In the light of the aforementioned discussion, there exists a need for a certain system and method for generating scores and assigning quality index to videos on digital platform with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and method for generating scores and assigning quality index to videos on digital platform.

Another objective of the present disclosure is directed towards enabling a user to record a video on a computing device.

Another objective of the present disclosure is directed towards enabling the user to upload offline recorded videos or photos on the computing device.

Another objective of the present disclosure is directed towards evaluating the user uploaded video into a number of different criteria and assigning a score on each.

Another objective of the present disclosure is directed towards assigning vector values to the video to measure the quality and potential virality of the video.

Another objective of the present disclosure is directed towards a system that calculates the sharpness of the video frames.

Another objective of the present disclosure is directed towards a system that calculates the brightness of the video frames.

Another objective of the present disclosure is directed towards a system that calculates the contrast of the video frames.

Another objective of the present disclosure is directed towards a system that calculates a number of faces in the video frames.

Another objective of the present disclosure is directed towards a system that calculates the percentage of the area of the frame taken up by faces and the area taken up by the face taking up the largest area.

Another objective of the present disclosure is directed towards a system that calculates the sentiment score of the video frames.

Another objective of the present disclosure is directed towards a system that detects the speech percentage in the video frames.

Another objective of the present disclosure is directed towards a system that detects labels for various actions in the video, such as talking, singing, dancing, etc., and assigns a score for each label.

Another objective of the present disclosure is directed towards a system that detects labels for various aspects of the video frames, such as the detection of objects, and identifying surroundings such as urban, or beaches, or mountains etc.

Another objective of the present disclosure is directed towards a system that detects noise levels in the audio from the video frames.

According to another exemplary aspect of the present disclosure, a computing device configured to establish communication with a server over a network, whereby the computing device comprises a video uploading module configured to enable a user to record one or more videos and allow the user to upload the one or more recorded videos on the computing device, wherein the video uploading module configured to transfer the one or more user uploaded videos from the computing device to a server over a network.

According to another exemplary aspect of the present disclosure, the server comprises a video evaluating module configured to receive the one or more user uploaded videos, whereby the video evaluating module is configured to identify one or more video frames of the one or more user uploaded videos, the video evaluating module configured to identify different criteria from the one or more video frames and evaluate the different criteria thereby assigning scores to the one or more video frames.

According to another exemplary aspect of the present disclosure, the video evaluating module is configured to compute a plurality of metrics of one or more video frames based on the assigned scores and calculate mean and median values of the plurality of metrics, thereby assigning the mean and median values to one or more video frame vectors.

According to another exemplary aspect of the present disclosure, the video evaluating module is configured to combine one or more video frame vectors of each video frame to obtain a final video vector and assign a weight to each value of the final video vector to identify a video quality index.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for generating scores and assigning quality index to videos on digital platform, in accordance with one or more exemplary embodiments.

FIG. 2 is a block diagram depicting an embodiment of the video uploading module 114 on the computing device and the video evaluating module 116 on the server of shown in FIG. 1, in accordance with one or more exemplary embodiments.

FIG. 3A, 3B, 3C, and 3D is an example diagrams depicting an embodiments of the system for generating scores and assigning quality index to videos on digital platform.

FIG. 4 is a flow diagram depicting a method for generating scores and assigning quality index to videos on digital platform, in accordance with one or more exemplary embodiments.

FIG. 5 is a flow diagram depicting a method for assigning scores to the video frames to form frame vectors for the video frames, in accordance with one or more exemplary embodiments.

FIG. 6 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

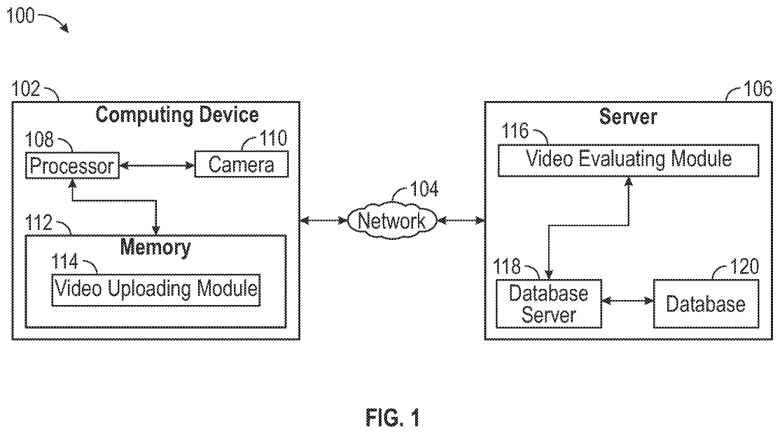

Referring to FIG. 1 is a block diagram 100 depicting a schematic representation of a system for generating scores and assigning quality index to videos on digital platform, in accordance with one or more exemplary embodiments. The system 100 includes a computing device 102, a network 104, a server 106, a processor 108, a camera 110, a memory 112, a video uploading module 114, a video evaluating module 116, a database server 118, and a database 120.

The computing device 102 may include users' devices. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102 may include the processor 108 in communication with a memory 112. The processor 108 may be a central processing unit. The memory 112 is a combination of flash memory and random-access memory.

The first computing device 102 may be communicatively connected to the server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing device 102 is shown in FIG. 1, an embodiment of the system 100 may support any number of computing devices. The computing device 102 may be operated by the users. The users may include, but not limited to, an individual, a client, an operator, a content creator, and the like. The computing device 102 supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing device 102 includes the camera 110 may be configured to enable the user to capture the multimedia objects using the processor 108. The multimedia objects may include, but not limited to photos, snaps, short videos, videos, and the like. The computing device 102 may include the video uploading module 114 in the memory 112.

The video uploading module 114 may be configured to enable the user to create or record the video or upload pre-recorded video or photo on the computing device 102. The video uploading module 114 may also be configured to enable the user to upload the recorded video on the computing device 102. The video uploading module 114 may be any suitable applications downloaded from GOOGLE PLAY® (for Google Android devices), Apple Inc.'s APP STORE® (for Apple devices), or any other suitable database. The video uploading module 114 may be desktop application which runs on Windows or Linux or any other operating system and may be downloaded from a webpage or a CD/USB stick etc. In some embodiments, the video uploading module 114 may be software, firmware, or hardware that is integrated into the computing device 102. The computing device 102 may present a web page to the user by way of a browser, wherein the webpage comprises a hyperlink may direct the user to uniform resource locator (URL).

The server 106 may include the video evaluating module 116, the database server 118, and the database 120. The video evaluating module 116 may be configured to evaluate the user uploaded video into a number of different criteria and assign a score on each. The video evaluating module 116 may also be configured to assign vector values to the user uploaded video to measure the quality and potential virality of the video. The video evaluating module 116 may also be configured to provide server-side functionality via the network 104 to one or more users. The database server 118 may be configured to access the one or more databases. The database 120 may be configured to store user created and recorded video. The database 120 may also be configured to store interactions between the modules of the video uploading module 114, and the video evaluating module 116.

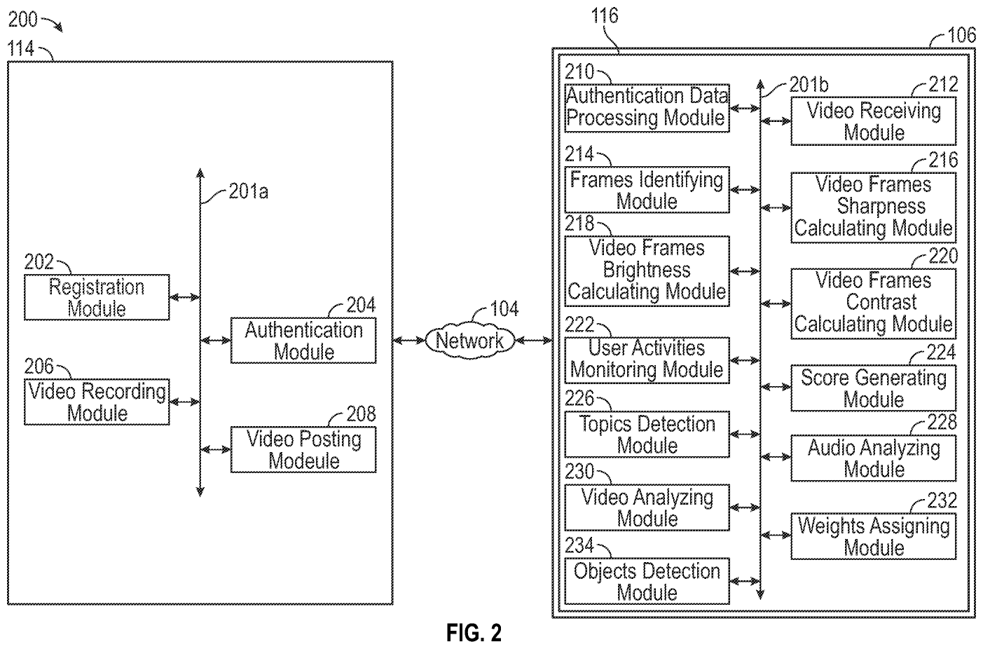

Referring to FIG. 2 is a block diagram 200 depicting an embodiment of the video uploading module 114 on the computing device and the video evaluating module 116 on the server of shown in FIG. 1, in accordance with one or more exemplary embodiments. The video uploading module 114 includes a bus 201a, a registration module 202, an authentication module 204, a video recording module 206, and a video posting module 208. The bus 201a may include a path that permits communication among the modules of the video uploading module 114 installed on the computing device 102. The term “module” is used broadly herein and refers generally to a program resident in the memory 112 of the computing device 102.

The registration module 202 may be configured to enable the user to register on the video uploading module 114 installed on the computing device 102 by providing basic details of the user. The basic details may include but not limited to email, password, first and last name, phone number, address details, and the like. The registration module 202 may also be configured to transfer the user registration details to the server 106 over the network 104. The server 106 may include the video evaluating module 116. The video evaluating module 116 may be configured to receive the user registration details from the registration module 202. The authentication module 204 may be configured to enable the user to log in and access the video uploading module 114 installed on the computing device 102 by using the user login identity credentials. The video recording module 206 may be configured to enable the user to tap a camera icon on the computing device 102 to record the video. The video recording module 206 may also be configured to enable the user to upload pre-recorded video on the computing device 102. The video posting module 208 may be configured to enable the user to upload the recorded video on the computing device 102. The video posting module 208 may also be configured to transfer the user uploaded video to the server 106 over the network 104. The video posting module 208 may also be configured to enable the user to upload the videos stored from the memory 112 of the computing device 102.

In accordance with one or more exemplary embodiments of the present disclosure, the video evaluating module 116 includes a bus 201b, an authentication data processing module 210, a video receiving module 212, a frames identifying module 214, a video frames sharpness calculating module 216, a video frames brightness calculating module 218, a video frames contrast calculating module 220, a user activities monitoring module 222, a score generating module 224, a topics detection module 226, an audio analyzing module 228, a video analyzing module 230, weights assigning module 232, and an objects detection module 234. The bus 201b may include a path that permits communication among the modules of the video evaluating module 116 installed on the server 106.

The authentication data processing module 210 may be configured to receive the user registration details from the registration module 202. The authentication data processing module 210 may also be configured to generate the user login identity credentials using the user registration details. The identity credentials comprise a unique identifier (e.g., a username, an email address, a date of birth, a house address, a mobile number, and the like), and a secured code (e.g., a password, a symmetric encryption key, biometric values, a passphrase, and the like). The video receiving module 212 may be configured to receive the user uploaded video from the video posting module 208. The frames identifying module 214 may be configured to identify the multiple video frames from the user uploaded video. The video frames sharpness calculating module 216 may be configured to calculate the sharpness of the video frames. The video frames sharpness calculating module 216 may use the convolving the image with a Laplacian kernel and then computing the variance of the resulting image. The video frames brightness calculating module 218 may be configured to calculate the brightness of the video frames by calculating the mean lightness value of each pixel in the HSL color space. The video frames contrast calculating module 220 may be configured to calculate the contrast of the video frames by comparing the darkest and lightest pixels in the image. The video frames contrast calculating module 220 may also be configured to calculate the contrast of the video frames through the root mean square contrast of the image. The video frames contrast calculating module 220 may also be configured to calculate the contrast of the video frames by dividing the image into regions, calculating the root mean square contrast of each region, and then comparing the darkest and lightest region in the image. The above methods may be used together, and each may be assigned its own score in the vector. Regions may also be divided in a number of different ways, and each approach may be assigned a score in the vector. The objects detection module 234 may be configured to calculate the number of objects in the video frames. The objects detection module 234 may also be configured to calculate the percentage of the area of the video frames taken up by the objects, as well as the area taken up by the objects taking up the largest area. The objects detection module 234 may also be configured to compute the area taken up by each individual object. The objects may include but not limited to faces and the like. The objects detection module 234 may also be configured to detect labels for various aspects of the video frames. The labels may include but are not limited to detecting objects and identifying surroundings such as urban, beaches, mountains, and the like. The user activities monitoring module 222 may be configured to calculate the user reputation values by observing the various activities performed by the user on the video uploading module 114. The user activities monitoring module 222 may also be configured to compute the user reputation values by observing the past performance videos of the user. The user activities monitoring module 222 may also be configured to compute the user reputation values based on the user's social media presence on other platforms. The score generating module 224 may be configured to calculate a sentiment score of the video frames. The sentiment score may include a positive or negative sentiment score. The sentiment score may include the user's mood; it may include casual or formal. The sentiment score may also include scores for emotions displayed in the video frames. The emotions may include but not limited to anger, happiness, sadness, excitement, and the like. The topics detection module 226 may be configured to detect topics from the video frames. The topics detection module 226 may also be configured to generate scores for each detected topic. The topics detection module 226 may also be configured to calculate the score of various aspects of each detected topic, such as how likely the topic is relevant to a large population or which niche the topic belongs to population. The audio analyzing module 228 may be configured to detect the speech percentage in the video frames by calculating when someone is speaking, and someone is silent in the video. The audio analyzing module 228 may also be configured to divide the video into video segments and assign the speech percentage value for each segment. The audio analyzing module 228 may also be configured to detect the type of audio in the video frames. The detected type of audio may include one or more categories. The one or more categories may include speech, music, nature, asmr, etc. The audio analyzing module 228 may also be configured to generate scores for each category. The audio analyzing module 228 may also be configured to divide the video into video segments and generate the metrics for each segment. The audio analyzing module 228 may also be configured to detect noise levels in the audio of the video frames.

The video analyzing module 230 may be configured to detect explicit content and generate the scores for video frames by detecting nudity or violence in the video frames. The video analyzing module 230 may also be configured to detect labels for various actions in the video frames. The labels may include but not limited to talking, singing, dancing, and the like. The score generating module 224 may also be configured to generate a score for each label. The video analyzing module 230 may also be configured to detect the multimedia content information from the video frames. The multimedia content information may include video frames comprising a still image, scene changes, slideshow of images, whether it is directly out of a camera, has post processing applied to it, or is entirely digitally constructed, and the like. The video analyzing module 230 may also be configured to detect the presence of watermarks from the video frames. The video analyzing module 230 may also be configured to detect the presence of a text watermark and the logo of another social app in the watermark. The video analyzing module 230 may also be configured to detect the presence of brand logos anywhere other than the watermark. The video analyzing module 230 may also be configured to detect the lip movement from the video frames. The video analyzing module 230 may also be configured to compute the lip movement that coincides with speech or other aspects of the audio. The video analyzing module 230 may also be configured to detect clothing in the video frames and assign the categories. The categories may include but not limited to casual, dressy, and the like. The score generating module 224 may also be configured to generate scores for each category. The weights assigning module 232 may be configured to assign a weight to each value of the final video vector to identify a video quality index. The objects detection module 234 may also be configured to detect object extraction applied to one or more video frames, a portion of the video, and the entire video. The video analyzing module 230 may also be configured to detect account transitions applied to one or more video frames. The video analyzing module 230 may also be configured to detect visual effects applied to one or more video frames. The video analyzing module 230 may also be configured to detect visual effects applied based on audio beats and synchronization of the visual effects and audio beats. The video analyzing module 230 may also be configured to detect the face and body of the objects to apply visual effects.

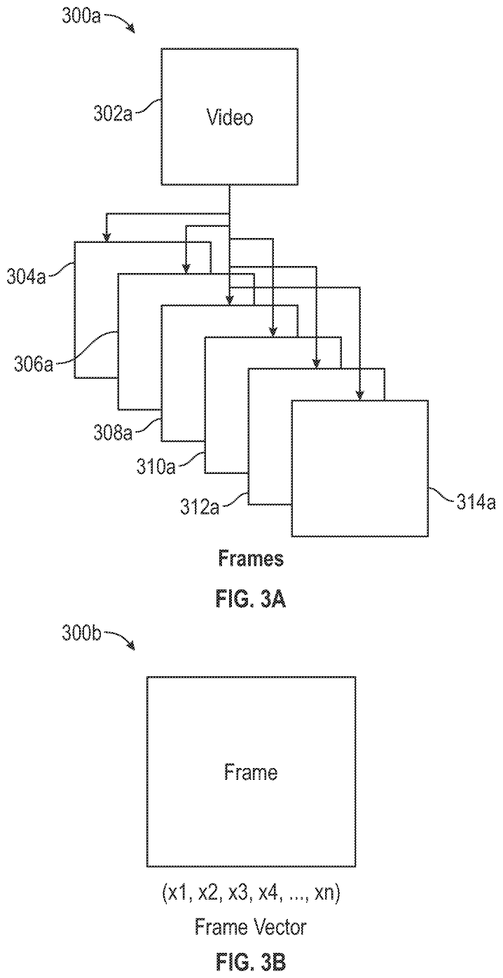

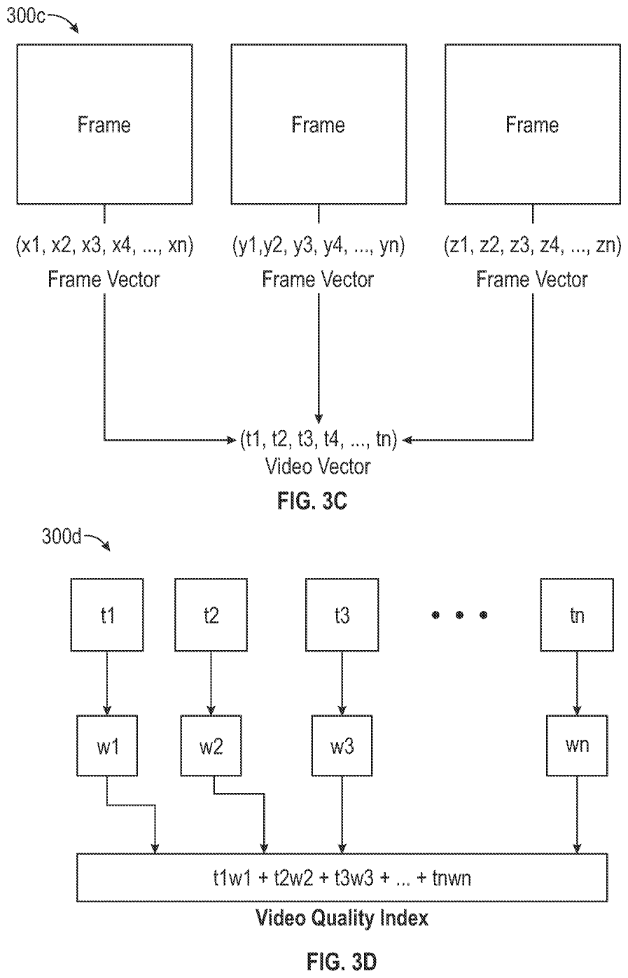

Referring to FIG. 3A, 3B, 3C, and 3D is an example diagrams 300a, 300b, 300c, 300d depicting embodiments of the system for generating scores and assigning quality index to videos on digital platform.

The video evaluating module 116 may be configured to identify video frames 304a, 306a, 308a, 310a, 312a, 314a from the user uploaded video 302a. The video evaluating module 116 may also be configured to identify different criteria from video frames 304a, 306a, 308a, 310a, 312a, 314a. The video evaluating module 116 may also be configured to evaluate the different criteria assigning scores to the video frames 304a, 306a, 308a, 310a, 312a, 314a. The video evaluating module 116 may also be configured to computing a plurality of metrics of the video frames 304a, 306a, 308a, 310a, 312a, 314a based on the assigned scores. The video evaluating module 116 may also be configured to calculate the mean and median values of the plurality of metrics and assigning the mean and median values to video frame vectors. Here frame vectors may include (x1, x2, x3, x4, . . . ,xn) (y1, y2, y3, y4, . . . ,yn) (z2, z2,z3,z4 . . . ,zn). The video evaluating module 116 may also be configured to combine the video frame vectors of each video frame to obtain a final video vector. Here final video vector may includes (t1, t2, t3, t4, . . . ,tn)The video evaluating module 116 may also be configured to assign a weight to each value of the final video vector to identify a video quality index by the video evaluating module. Here weights may include (w1, w2, w3, w4, . . . ,wn), and the video quality index may include (t1w1+t2w2+t3w3+ . . . +tnwn).

In accordance with one or more exemplary embodiments of the present disclosure, a frame from every second of the video may be taken to compute all metrics. The mean and median values of all the frames are calculated and assigned to the vector for the video. Each metric may include two scores, the mean and the median. The metrics may be computed on each frame of the video, or a frame once every n frame, or a frame once every n seconds. Scene changes may be computed in the video, and one frame may be taken for each scene The method for combining the vectors of each frame into the final vector for the video may also take into account more strategies, such as taking percentiles at different intervals in addition to the mean and median. It may also include values by computing the mean of values falling within particular percentile ranges. It may include the min and max values of each metric from the frames. It may also take into account all of the values of the individual frame vectors, thus concatenating the frame vectors to form the video vector. It may also use multiple of these techniques, using a different technique for a different subset of metrics. The video evaluating module 116 may also be configured to combine the values of the video vector and computes different video quality indexes based on different scenarios. The video quality index for a particular scenario like detection of very poor quality videos may be different from the video quality index computed for a different scenario, like the detection of very good quality videos. The video quality index may be a single value, or may be a vector of values itself, in accordance to its use in the particular scenario it is computed for. The video evaluating module 116 may also be configured to calculate the video quality index by assigning a weight to each value in the video quality vector and then adding up all the values, resulting in a linear combination. The video evaluating module 116 may also be configured to feed the inputs to a machine learning algorithm like a neural network, and train a much larger set of weights using required values for the video quality index as the outputs for that particular scenario. The weights may be used to compute the video quality index for that scenario from the video quality vector.

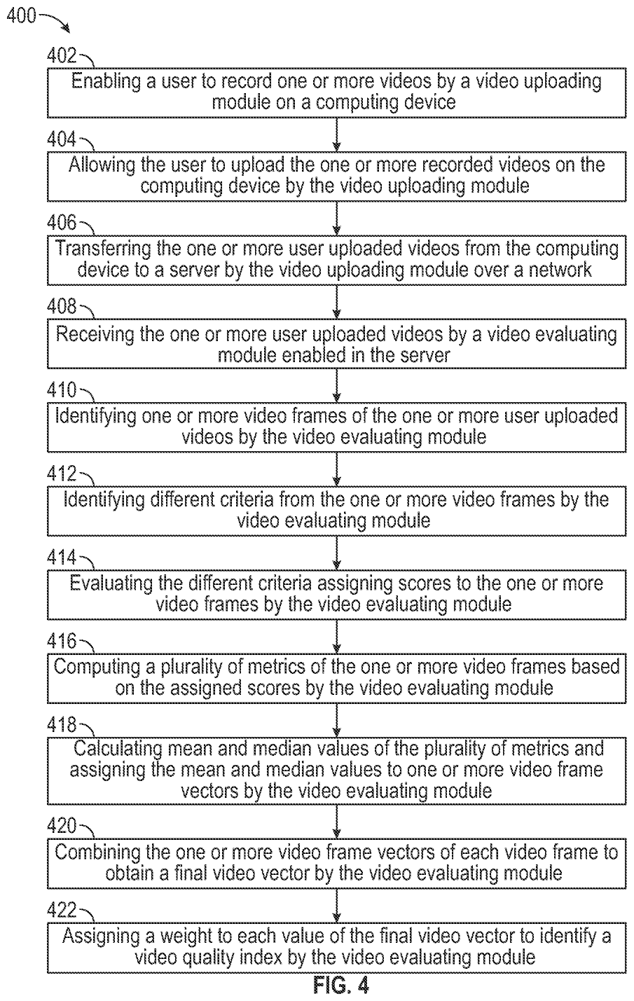

Referring to FIG. 4 is a flow diagram 400 depicting a method for generating scores and assigning quality index to videos on digital platform, in accordance with one or more exemplary embodiments. The method 400 may be carried out in the context of the details of FIG. 1, FIG. 2, FIG. 3A, FIG. 3B, FIG. 3C, and FIG. 3D. However, the method 400 may also be carried out in any desired environment. Further, the aforementioned definitions may equally apply to the description below.

The method commences at step 402, enabling the user to record one or more videos by the video uploading module on the computing device. Thereafter at step 404, allowing the user to upload the one or more recorded videos on the computing device by the video uploading module. Thereafter at step 406, transferring the one or more user uploaded videos from the computing device to a server by the video uploading module over the network. Thereafter at step 408, receiving the one or more user uploaded videos by a video evaluating module enabled in the server. Thereafter at step 410, identifying one or more video frames of the one or more user uploaded videos by the video evaluating module. Thereafter at step 412, identifying different criteria from the one or more video frames by the video evaluating module. Thereafter at step 414, evaluating the different criteria assigning scores to the one or more video frames by the video evaluating module. Thereafter at step 416, computing a plurality of metrics of the one or more video frames based on the assigned scores by the video evaluating module. Thereafter at step 418, calculating mean and median values of the plurality of metrics and assigning the mean and median values to one or more video frame vectors by the video evaluating module. Thereafter at step 420, combining the one or more video frame vectors of each video frame to obtain a final video vector by the video evaluating module. Thereafter at step 422, assigning a weight to each value of the final video vector to identify a video quality index by the video evaluating module.

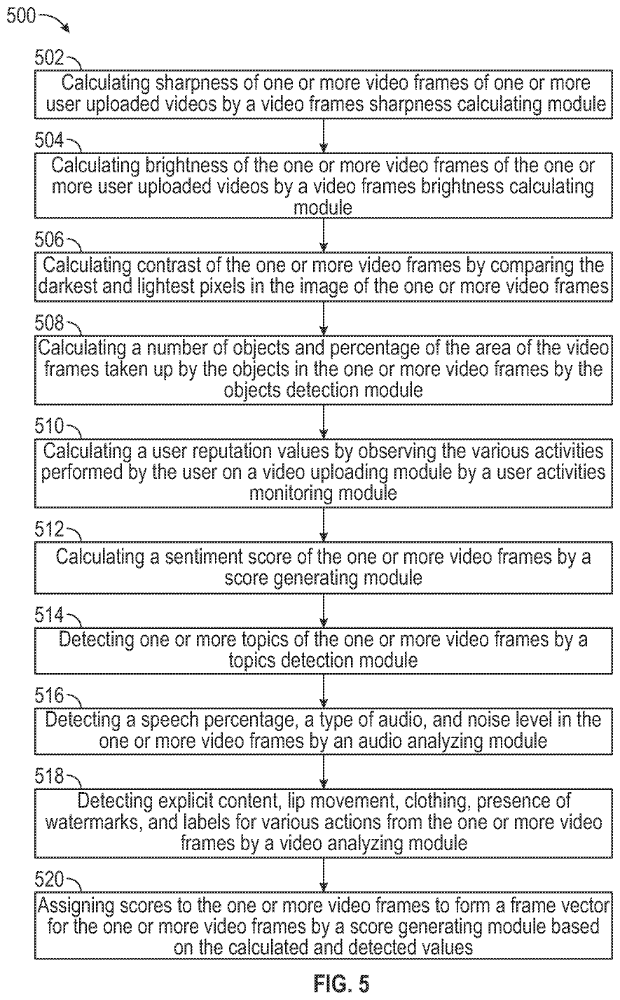

Referring to FIG. 5 is a flow diagram 500 depicting a method for assigning scores to the video frames to form a frame vector for the video frames, in accordance with one or more exemplary embodiments. The method 500 may be carried out in the context of the details of FIG. 1, FIG. 2, FIG. 3A, FIG. 3B, FIG. 3C, FIG. 3D and FIG. 4. However, the method 500 may also be carried out in any desired environment. Further, the aforementioned definitions may equally apply to the description below.

The method commences at step 502, calculating the sharpness of one or more video frames of one or more user uploaded videos by the video frames sharpness calculating module. Thereafter at step 504, calculating the brightness of the one or more video frames of the one or more user uploaded videos by the video frames brightness calculating module. Thereafter at step 506, calculating the contrast of the one or more video frames by comparing the darkest and lightest pixels in the image of the one or more video frames. Thereafter at step 508, calculating the number of objects and percentage of the area of the video frames taken up by the objects in the one or more video frames by the objects detection module. Thereafter at step 510, calculating the user reputation values by observing the various activities performed by the user on a video uploading module by the user activities monitoring module. Thereafter at step 512, calculating a sentiment score of the one or more video frames by the score generating module. Thereafter at step 514, detecting one or more topics of the one or more video frames by the topics detection module. Thereafter at step 516, detecting a speech percentage, a type of audio, and noise level in the one or more video frames by an audio analyzing module. Thereafter at step 518, detecting explicit content, lip movement, clothing, presence of watermarks, and labels for various actions from the one or more video frames by a video analyzing module. Thereafter at step 520, assigning scores to the one or more video frames to form a frame vector for the one or more video frames by the score generating module based calculated and detected values.

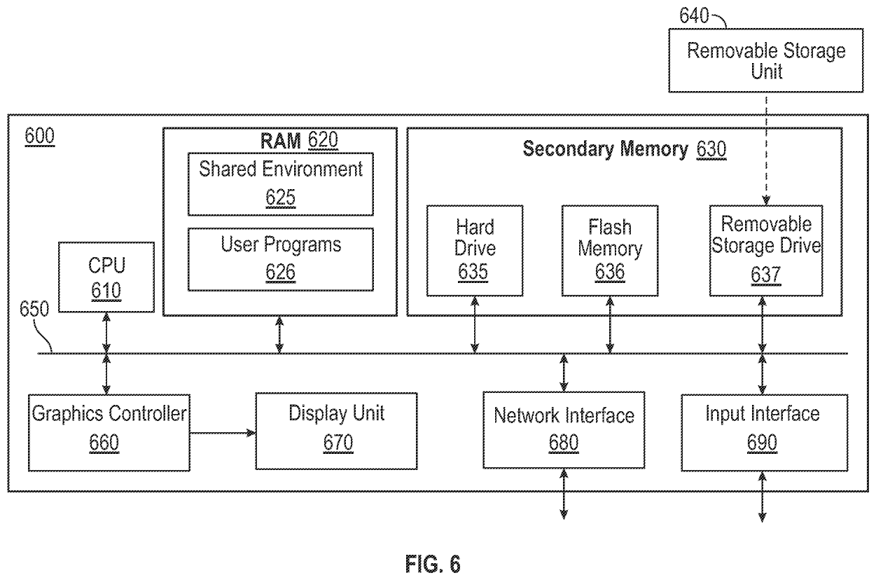

Referring to FIG. 6 is a block diagram 600 illustrating the details of a digital processing system 600 in which various aspects of the present disclosure are operative by execution of appropriate software instructions. The Digital processing system 600 may correspond to the computing device 102 (or any other system in which the various features disclosed above can be implemented).

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail. CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions, such as those used in threads and stacks, constituting shared environment 625 and/or user programs 626. Shared environment 625 includes operating systems, device drivers, virtual machines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (such as those shown in FIG. 1) connected to the network 104.

Secondary memory 630 may contain hard drive 635, flash memory 636, and removable storage drive 637. Secondary memory 630 may store the data software instructions (e.g., for performing the actions noted above with respect to the Figures), which enable digital processing system 600 to provide several features in accordance with the present disclosure.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EEPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 650. Transmission media can also take the form of acoustic or light waves, such as those generated during radio-wave and infra-red data communications.

According to an exemplary aspect of the present disclosure, enabling a user to record one or more videos by a video uploading module on a computing device.

According to an exemplary aspect of the present disclosure, allowing the user to upload the one or more recorded videos on the computing device by the video uploading module.

According to an exemplary aspect of the present disclosure, transferring the one or more user uploaded videos from the computing device to a server by the video uploading module over a network.

According to an exemplary aspect of the present disclosure, receiving the one or more user uploaded videos by a video evaluating module enabled in the server.

According to an exemplary aspect of the present disclosure, identifying one or more video frames of the one or more user uploaded videos by the video evaluating module.

According to an exemplary aspect of the present disclosure, identifying different criteria from the one or more video frames by the video evaluating module.

According to an exemplary aspect of the present disclosure, evaluating the different criteria assigning scores to the one or more video frames by the video evaluating module.

According to an exemplary aspect of the present disclosure, computing a plurality of metrics of the one or more video frames based on the assigned scores by the video evaluating module.

According to an exemplary aspect of the present disclosure, calculating mean and median values of the plurality of metrics and assigning the mean and median values to one or more video frame vectors by the video evaluating module.

According to an exemplary aspect of the present disclosure, combining the one or more video frame vectors of each video frame to obtain a final video vector by the video evaluating module.

According to an exemplary aspect of the present disclosure, assigning a weight to each value of the final video vector to identify a video quality index by the video evaluating module.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for generating scores and assigning quality index to videos on digital platform, comprising:
enabling a user to record one or more videos by a video uploading module on a computing device;
allowing the user to upload the one or more recorded videos on the computing device by the video uploading module;
transferring the one or more user uploaded videos from the computing device to a server by the video uploading module over a network;
receiving the one or more user uploaded videos by a video evaluating module enabled in the server;
identifying one or more video frames of the one or more user uploaded videos by the video evaluating module;
identifying different criteria from the one or more video frames by the video evaluating module;
evaluating the different criteria assigning scores to the one or more video frames by the video evaluating module;
computing a plurality of metrics of the one or more video frames based on the assigned scores by the video evaluating module;
calculating mean and median values of the plurality of metrics and assigning the mean and median values to one or more video frame vectors by the video evaluating module;
combining the one or more video frame vectors of each video frame to obtain a final video vector by the video evaluating module; and
assigning a weight to each value of the final video vector to identify a video quality index by the video evaluating module.

2. The method of claim 1, comprising a step of enabling the user to tap a camera icon to record one or more videos on the computing device by a video recording module.

3. The method of claim 1, comprising a step of enabling the user to upload the one or more recorded videos on the computing device by a video posting module.

4. The method of claim 1, comprising a step of receiving the one or more user uploaded videos from the video posting module by a video receiving module.

5. The method of claim 1, comprising a step of identifying one or more video frames of the one or more user uploaded videos by a frames identifying module.

6. The method of claim 5, comprising a step of calculating sharpness of one or more video frames of the one or more user uploaded videos by a video frames sharpness calculating module.

7. The method of claim 5, comprising a step of calculating brightness of the one or more video frames of the one or more user uploaded videos by a video frames brightness calculating module.

8. The method of claim 5, comprising a step of calculating contrast of the one or more video frames by comparing the darkest and lightest pixels in the image of the one or more video frames by a video frames contrast calculating module.

9. The method of claim 5, comprising a step of calculating a number of objects and percentage of the area of the one or more video frames taken up by the objects in the one or more video frames by an objects detection module.

10. The method of claim 5, comprising a step of detecting one or more labels for various aspects of the one or more video frames by the objects detection module.

11. The method of claim 5, comprising a step of calculating the user reputation values by observing the various activities performed by the user on the video uploading module by a user activities monitoring module.

12. The method of claim 5, comprising a step of calculating a sentiment score of the one or more video frames of the one or more user uploaded videos by a score generating module.

13. The method of claim 5, comprising a step of detecting one or more topics of the one or more video frames by a topics detection module.

14. The method of claim 5, comprising a step of detecting a speech percentage, a type of audio, and noise level in the one or more video frames by an audio analyzing module.

15. The method of claim 5, comprising a step of detecting lip movements, clothing, and labels for various actions from the one or more video frames by a video analyzing module.

16. The method of claim 5, comprising a step of detecting explicit content through detecting nudity or violence from the one or more video frames by the video analyzing module.

17. The method of claim 5, comprising a step of detecting the presence of watermarks, a text watermarks, a logo of another social app in the watermarks, and brand logos anywhere other than the watermarks by the video analyzing module.

18. The method of claim 5, comprising a step of detecting object extraction applied to the one or more video frames, a portion of the video, and the entire video by the objects detection module.

19. The method of claim 5, comprising a step of detecting account transitions applied to the one or more video frames by the video analyzing module.

20. The method of claim 5, comprising a step of detecting visual effects applied to the one or more video frames by the video analyzing module.

21. The method of claim 5, comprising a step of detecting visual effects applied based on audio beats and synchronization of the visual effects and audio beats by the video analyzing module.

22. The method of claim 5, comprising a step of detecting the face and body of the objects to apply visual effects by the video analyzing module.

23. The method of claim 5, comprising a step of assigning scores to the one or more video frames to form a frame vector for the one or more video frames by a score generating module based on the calculated and detected values.

24. A system for generating scores and assigning quality index to videos on digital platform, comprising:
a computing device configured to establish communication with a server over a network, whereby the computing device comprises a video uploading module configured to enable a user to record one or more videos and allow the user to upload the one or more recorded videos on the computing device, wherein the video uploading module configured to transfer the one or more user uploaded videos from the computing device to a server over a network;
the server comprising a video evaluating module configured to receive the one or more user uploaded videos, whereby the video evaluating module configured to identify one or more video frames of the one or more user uploaded videos, the video evaluating module configured to identify different criteria from the one or more video frames and evaluate the different criteria thereby assigning scores to the one or more video frames; and
the video evaluating module configured to compute a plurality of metrics of the one or more video frames based on the assigned scores and calculate mean and median values of the plurality of metrics, thereby assigning the mean and median values to one or more video frame vectors, the video evaluating module configured to combine the one or more video frame vectors of each video frame to obtain a final video vector and assigning a weight to each value of the final video vector to identify a video quality index.

25. A computer program product comprising a non-transitory computer-readable medium having a computer-readable program code embodied therein to be executed by one or more processors, said program code including instructions to:
enable a user to record one or more videos by a video uploading module on a computing device;
allow the user to upload the one or more recorded videos on the computing device by the video uploading module;
transfer the one or more user uploaded videos from the computing device to a server by the video uploading module over a network;
receive the one or more user uploaded videos by a video evaluating module enabled in the server;
identify one or more video frames of the one or more user uploaded videos by the video evaluating module;
identify different criteria from the one or more video frames by the video evaluating module;
evaluate the different criteria assigning scores to the one or more video frames by the video evaluating module;
compute a plurality of metrics of the one or more video frames based on the assigned scores by the video evaluating module;
calculate mean and median values of the plurality of metrics and assign the mean and median values to one or more video frame vectors by the video evaluating module;
combine the one or more video frame vectors of each video frame to obtain a final video vector by the video evaluating module; and
assign a weight to each value of the final video vector to identify a video quality index by the video evaluating module.
